(19) United States
(12) Patent Application Publication
(10) Pub. No.: US 2011/0228071 A1
(43) Pub. Date: Sep. 22, 2011

(54) Microscope for Forensic Examination

(76) Inventors: Mitchell M. Rohde, Saline, MI (US); Robert M. Lupa, Vernon, IL (US); Christopher Showers, Royal Oak, MI (US); Phil Munie, Canton, MI (US); Kevin D. Melotti, Portage, MI (US); Michael G. Ploof, Ann Arbor, MI (US); Steven M. Rohde, Ann Arbor, MI (US)

(21) Appl. No.: 13/024,871

(22) Filed: Feb. 10, 2011

Related U.S. Application Data
(60) Provisional application No. 61/303,169, filed on Feb. 10, 2010.

(51) Int. Cl. H04N 7/18

(52) U.S. Cl. 348/79; 348/E07.085

(57) ABSTRACT

A remote forensic evidentiary item examination system includes a first station and a second station. The first station is locatable at a first location, and is adapted to have a forensic evidentiary item mounted at a fixture thereof. The second station is locatable at a second location different than and remote to the first location, and is in communicative connection with the first station. The second station is adapted to permit a user at the second location to examine the forensic evidentiary item at the first location.

### RELATED APPLICATIONS

The present patent application claims priority to the previously filed and presently pending provisional patent application entitled “Microscope for Forensic Examination,” filed on Feb. 10, 2010, assigned application No. 61/303,169, and which is hereby incorporated in its entirety by reference.

### BACKGROUND

Forensic evidentiary item examination is a process commonly performed during and for investigations and legal proceedings. Law enforcement at the scene of a crime, for instance, may recover a bullet, and may then subsequently recover a firearm at the residence of a potential suspect. To determine whether the bullet was fired from the firearm, a forensic expert is employed. The forensic expert may fire another bullet from the recovered gun, and compare the two bullets to determine if the recovered bullet was indeed fired from the recovered firearm.

### SUMMARY

A remote forensic evidentiary item examination system can include a first station and a second station. The first station is locatable at a first location, and the second station is locatable at a second location different than and remote to the first location. The first station is adapted to have a forensic evidentiary item mounted at a fixture thereof. The second station is in communicative connection with the first station. The second station is adapted to permit a user at the second location to examine the forensic evidentiary item at the first location. Other aspects and embodiments of the invention will become apparent by reading the description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a block diagram of a remote forensic evidentiary item examination system, according to an embodiment of the invention.

FIG. 2 is a diagram of an exemplary station of a remote forensic evidentiary item examination system in partial detail, according to an embodiment of the invention.

FIG. 3 is a flowchart of a method for remote forensic evidentiary examination, according to an embodiment of the invention.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the embodiment of the invention is defined only by the appended claims.

As noted in the background section, forensic evidentiary item examination is a process that is commonly performed during and for investigations and legal proceedings. Forensic experts require substantial expertise and training to ensure that the results they provide are sufficiently accurate to be used in such investigations and legal proceedings. However, forensic experts may not be located in the same place where the forensic evidentiary items that they are to examine are located.

For instance, military forensic experts may be asked to examine forensic evidentiary items that are located across the globe. As another example, domestic law enforcement is increasingly expected to cover criminal cases over wider geographic areas, with fewer resources. In both these cases, a forensic expert may thus have to travel to the location of the recovered evidence, or the recovered evidence may have to be sent to the location of the forensic expert. In the former case, the time of the forensic expert is wasted traveling, whereas in the latter case, questions can be raised as to whether the evidence was tampered during transport.

Embodiments of the invention disclosed herein, by comparison, permit remote forensic evidentiary item examination. A system can include two stations. A first station can be located where the forensic evidentiary item is, or to where the forensic evidentiary item can be easily and securely shipped. The first station is adapted to have the forensic evidentiary item mounted at a fixture thereof.

A second station can be located at a different location, remote to the location of the first station. For instance, the second station can be located where a particular forensic expert is located, or where a forensic expert can easily or expediently travel. The two stations are in communicative connection with one another. The second station is adapted to permit a user, such as a forensic expert, to remotely examine the forensic evidentiary item.

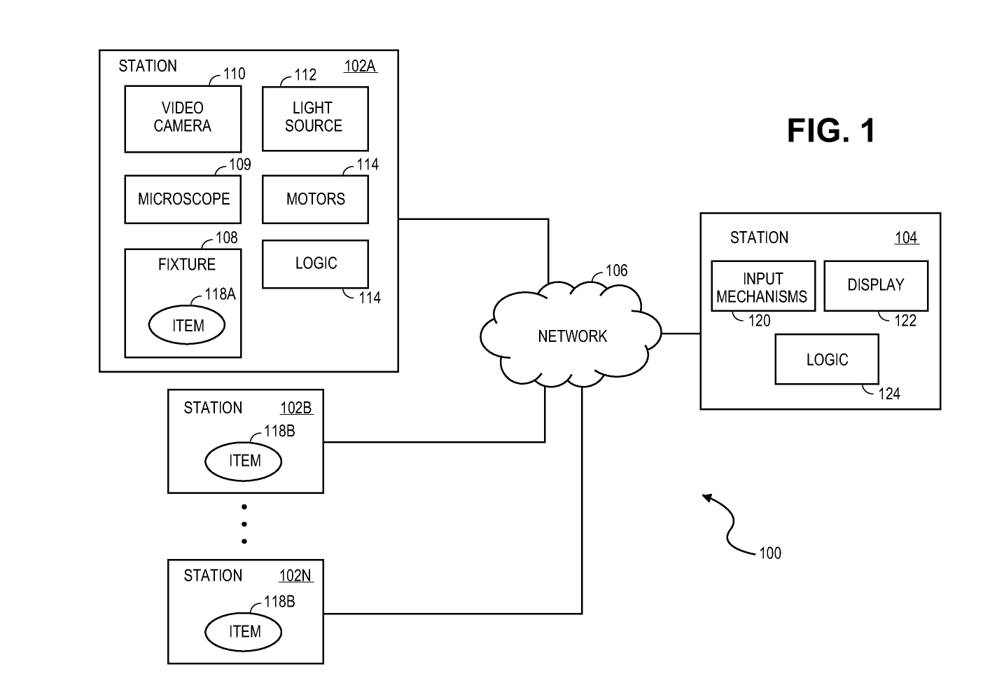

FIG. 1 is a block diagram of a remote forensic evidentiary item examination system, according to an embodiment of the invention. The system 100 includes a number of stations 102A, 102B, . . . , 102N, collectively referred to as the stations 102. There is at least one station 102, and the station 102 is described herein as representative and exemplary of all the stations 102. The system 100 further includes a station 104.

The station 102A and the station 104 are in indirect communicative connection with one another via a network 106 in the embodiment of FIG. 1. However, in other embodiments, the stations 102A and 104 may be in direct communicative connection with one another, in lieu of using the network 106. The network 106 may be or include such diverse networks as the Internet, intranets, extranets, wide-area networks (WANs), local-area networks (LANs), landline and mobile telephony networks, satellite links, wireless networks, and wired networks, among other types of networks.

The station 102A is located at a location different than and remote to the station 104. A forensic evidentiary item 118A is located at the station 102A, whereas a user, such as a forensic expert, is located at the station 104. More generally, forensic evidentiary items 118A, 118B, . . . , 118N, collectively referred to as the evidentiary items 118, are located at the stations 102, as depicted in FIG. 1. There may further be more than one forensic evidentiary item 118 located at each station 102.

In general, a forensic evidentiary item 118 is a piece of physical evidence that requires examination during the course of or for an investigation or a proceeding. Examples of such investigations and proceedings include criminal investigations and legal proceedings. Examples of forensic evidentiary items 118 include bullets or cartridges, thread or fiber samples, fingerprints, blood samples, documents, as well as other types of forensic evidentiary items.

The station 102A includes a fixture 108, a microscope 109, a video camera 110, a light source 112, one or more motors 114, and logic 116. The forensic evidentiary item 118A is mounted at the fixture 108. The forensic evidentiary item 118A is viewed through the microscope 109. The video camera 110 transmits video of the forensic evidentiary item 118A mounted at the fixture 108 to the station 104, as viewed through the microscope 109, through the network 106. The light source 112 illuminates the forensic evidentiary item 118A mounted at the fixture 108. The motors 114 physically move at least a portion of the fixture 108 so that desired portions of the forensic evidentiary item 118A are incident to the video camera 110.

The logic 116 is implemented as software stored on a non-transitory computer-readable data storage medium that is executed by a processor. The logic 116 receives commands from the station 104, through the network 106, for controlling the video camera 110, the light source 112, and the motors 114. The logic 116 further may perform image processing, or another type of digital signal processing, on the video output by the video camera 110 prior to transmission to the station 104.

The station 104 includes one or more input mechanisms 120, a display 122, and logic 124. The input mechanisms 120 can include keyboards, pointing devices such as mice and trackpads, as well as microphones, joysticks and other types of input mechanisms. The input mechanisms 120 are used to control the video camera 110, the light source 112, and the motors 114 of the station 102A. The input mechanisms 120 may also be used by a user at the station 104, such as a forensic expert, to communicate with a user at the station 102A, such as a technician.

The display 122 can be or include flat-panel displays, cathode-ray tube displays, and other types of displays. The display 122 is used to display the video of the forensic evidentiary item 118A (or items 118) mounted at the fixture 108 of the station 102A as transmitted by the video camera 110. The display 122 may also be used to display a graphical user interface that is manipulated by the user at the station 104 to control the video camera 110, the light source 112, and the motors 114 of the station 102A. The display 122 may further be used for communication purposes between the user at the station 104 and the user at the station 102A station, such as via text, video, and/or audio chat and/or conferencing.

The logic 116 is implemented as software stored on a non-transitory computer-readable data storage medium that is executed by a processor. The logic 116 receives commands input by the user at the station 104 via the input mechanisms 120, and transmits the commands to the station 102A. The logic 116 further receives the video of the forensic evidentiary item 118A mounted at the fixture 108, as transmitted by the video camera 110, and displays the video on the display 122. It is noted that the stations 102 and 104 may include other components, in addition to and/or in lieu of those depicted in FIG. 1.

In operation of the remote forensic evidentiary item system 100, a forensic expert at the station 104 is remote to the forensic evidentiary item 118A mounted at the fixture 108 of the station 102A. A technician or other user at the station 102A may only be required to mount the forensic evidentiary item 118A at the fixture 108. Thereafter, the station 104 permits the forensic expert (or other user) to examine the forensic evidentiary item 118A without (or with extremely limited) further assistance from any user at the station 102A. When multiple forensic evidentiary items 118 are present at the station 102A, or when multiple forensic evidentiary items 118 are present at multiple stations 102, the forensic expert can examine each such item 118, and compare the items 118 with one another.

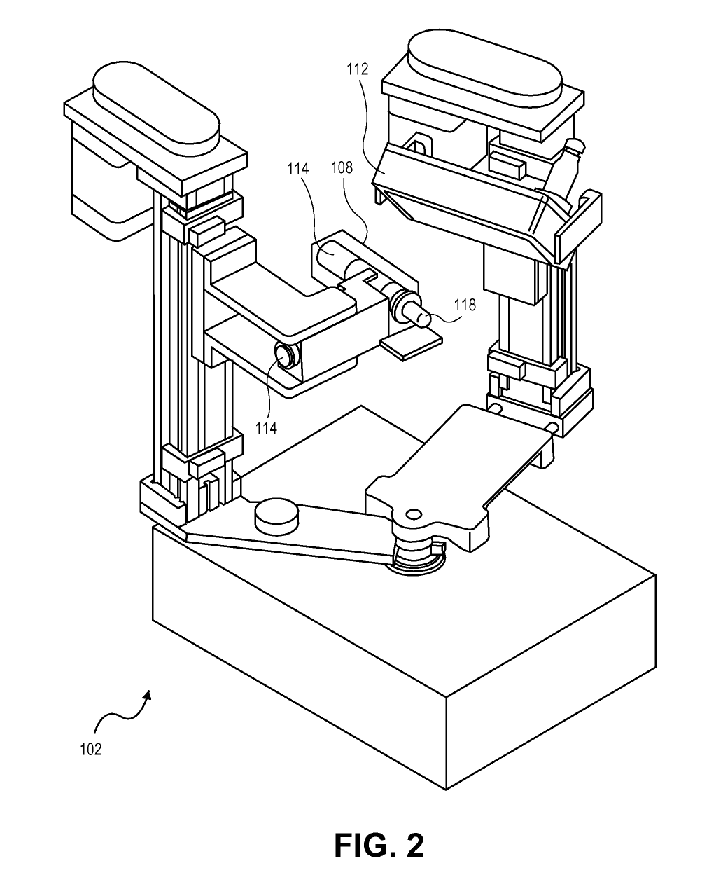

FIG. 2 shows an exemplary station 102 in partial detail, according to an embodiment of the invention. Particularly, the station 102 is for remote forensic examination of a forensic evidentiary item 118 that is a bullet. The fixture 108, the light source 112, and two motors 114 are depicted in FIG. 2. For illustrative clarity and convenience, however, the microscope 109, the video camera 110, and the logic 116 are not depicted in FIG. 2. The forensic evidentiary item 118—i.e., a bullet—is mounted at the fixture 108. The light source 112 illuminates the forensic evidentiary item 118. One motor 114 permits rotation of the forensic evidentiary item 118 about a central axis of the item 118. Another motor 114 permits rotation of the forensic evidentiary item 118 end-over-end.

A forensic expert remotely located at the station 104 is thus able to control which portion of the forensic evidentiary item 118 is incident to the video camera 110 via remote control of the motors 114. The forensic expert is able to control illumination of this portion of the forensic evidentiary item 118 via remote control of the light source 112. The forensic expert is further able to control the video camera 110, such as to zoom, focus, pan, and so on, the forensic evidentiary item 118 within the video transmitted by the video camera 110 to the station 104. All such control may be effected without any assistance from any user at the station 102.

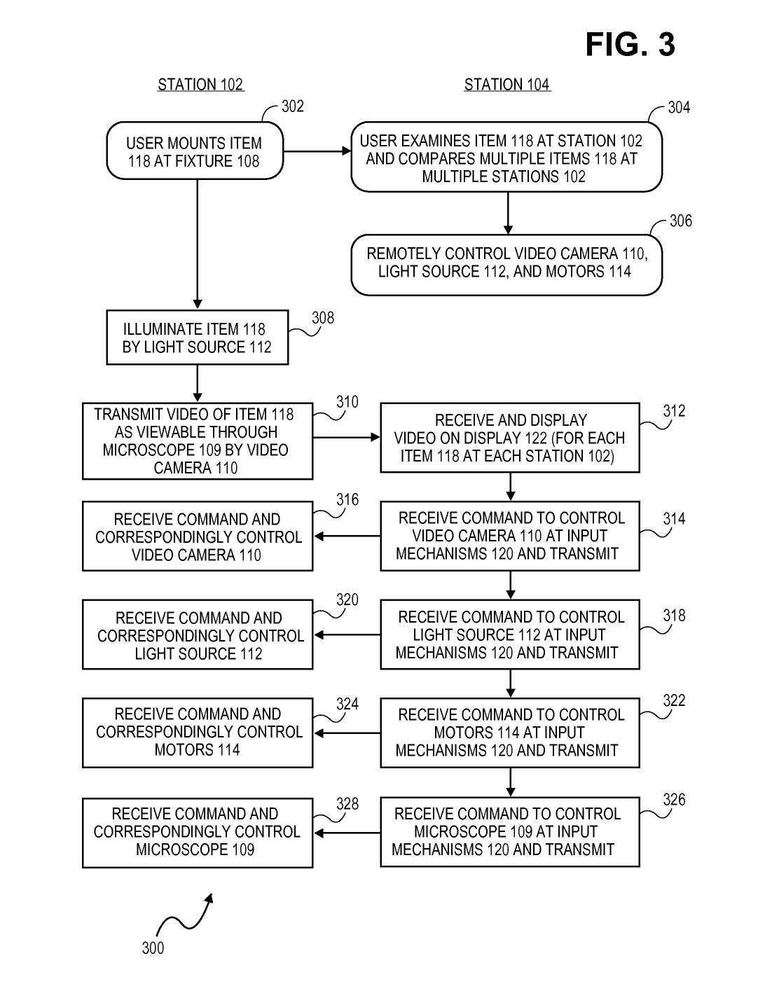

FIG. 3 shows a representative method 300 that can be performed in conjunction with the remote forensic evidentiary item examination system 100 that has been described, according to an embodiment of the invention. The left parts of the method 300 are performed by each of one or more of the stations 102, and the right parts of the method 300 are performed by the station 104. For each of at least some parts of the left parts and the right parts, the method 300 can be implemented as a computer program stored on a non-transitory computer-readable data storage medium, and executable by a processor. For instance, the logic 116 and 124 can perform at least some parts of the method 300.

In general, a user like a technician mounts a forensic evidentiary item 118 at a fixture 108 of a station 102 (302). A user like a forensic expert then examines the item 118 mounted at the station 102, and can compare multiple items 118 mounted at multiple stations 102 (304). This user can further remotely control the video camera 110, the light source 112, and the motors 114 at each station 102 (306).

More specifically, after the user at the station 102 has mounted a forensic evidentiary item 118 at the fixture 108, the light source 112 illuminates the item 118 (308). The video camera 110 then transmits video of the forensic evidentiary item 118 as viewable through the microscope 109 (310), which is received at the station 104 and is displayed on the display 122 (312), for each item 118 mounted at each station 102.

The station 104 can receive a command at the input mechanisms 120 to control the video camera 110 as effected by a user at the station 104, and transmit this command (314). The command is received at the station 102 for which the command is intended, and the video camera 110 is correspondingly controlled (316), such as without any assistance from any user at this station 102. For instance, the video camera 110 may be controlled to perform zoom, pan, and/or focus operations, among other types of operations that the video camera 110 can perform.

The station 104 can also receive a command at the input mechanisms 120 to control the light source 112 as effected by a user at the station 104, and transmit this command (318). The command is received at the station 102 for which the command is intended, and the light source 112 is correspondingly controlled (320), such as without any assistance from any user at this station 102. For instance, the light source 112 may be controlled to vary the amount and type of illumination output by the light source 112 and directed onto the forensic evidentiary item 118 in question.

The station 104 can further receive a command at the input mechanisms 120 to control the motors 114 as effected by a user at the station 104, and transmit this command (322). The command is received at the station 102 for which the command is intended, and the motors 114 are correspondingly controlled (324), such as without any user assistance from any user at this station 102. For instance, the motors 114 may be controlled to move the forensic evidentiary item 118 in question so that a desired portion of the item 118 is incident to the video camera 110.

The station 104 can further receive a command at the input mechanisms 120 to control the microscope 109 as effected by a user at the station 104, and transmit this command (326). The command is received at the station 102 for which the command is intended, and the microscope 109 is correspondingly controlled (328), such as without any user assistance from any user at this station 102. For instance, the microscope 109 can be controlled to change the lens through which forensic evidentiary item 118 is viewed, as well as focus and zoom of the microscope 109 in relation to the item 118. Other ways in which the microscope 109 can be controlled include controlling the stage and diaphragm positions of the microscope 109, the light intensity of any internal light of the microscope 109, as well as for certain types of microscopes 109, the objective lens(es) of the microscope 109.

Embodiments of the invention that have been described permit remote forensic evidentiary item examination. A user, such as a forensic expert, does not have to be located at the same location where the forensic evidentiary item is currently located. This is advantageous, because it means that a forensic expert can leverage his or her skills over a larger geographical area in a time and cost-effective manner.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such and therefore, it is manifestly intended that this invention be limited only by the claims and equivalents thereof.

We claim:

1. A remote forensic evidentiary examination system comprising:
a first station locatable at a first location, the first station adapted to have a forensic evidentiary item mounted at a fixture thereof, the first station comprising:
a video camera to transmit video of the forensic evidentiary item mounted at the fixture of the first station to the second station for viewing by the user;
a microscope through which the forensic evidentiary item is examined;
one or more motors to move the forensic evidentiary item while the forensic evidentiary item is mounted at the fixture of the first station;
a light source to illuminate the forensic evidentiary item mounted at the fixture of the first station; and,
a second station locatable at a second location different than and remote to the first location, the second station in communicative connection with the first station, the second station adapted to permit a user at the second location to examine the forensic evidentiary item at the first location,
wherein the second station is further adapted to permit the user to control the video camera, the microscope, the one or more motors, and the light source.

2. A remote forensic evidentiary item examination system comprising:
a first station locatable at a first location, the first station adapted to have a forensic evidentiary item mounted at a fixture thereof; and,
a second station locatable at a second location different than and remote to the first location, the second station in communicative connection with the first station, the second station adapted to permit a user at the second location to examine the forensic evidentiary item at the first location.

3. The remote forensic evidentiary item examination system of claim 2, wherein the first station comprises a video camera to transmit video of the forensic evidentiary item mounted at the fixture of the first station to the second station for viewing by the user,
and wherein the second station is further adapted to permit the user to control the video camera without assistance from any user at the first location.

4. The remote forensic evidentiary item examination system of claim 2, wherein the first station comprises a microscope through which the forensic evidentiary item is examined,
and wherein the second station is further adapted to permit the user to control the microscope without assistance from any user at the first location.

5. The remote forensic evidentiary item examination system of claim 2, wherein the first station comprises one or more motors to move the forensic evidentiary item while the forensic evidentiary item is mounted at the fixture of the first station,
and wherein the second station is further adapted to permit the user to control the one or more motors without assistance from any user at the first location.

6. The remote forensic evidentiary item examination system of claim 2, wherein the first station comprises a light source to illuminate the forensic evidentiary item mounted at the fixture of the first station,
and wherein the second station is further adapted to permit the user to control the light source without assistance from any user at the first location.

7. The remote forensic evidentiary item examination system of claim 2, further comprising a third station locatable at a third location different than and remote to both the first location and the second location, the third station adapted to have an additional evidentiary item mounted at an additional fixture thereof,
wherein the second station is in communicative connection with the third station, the second station adapted to permit the user at the second location to examine the additional forensic evidentiary item at the third location, and to compare the additional forensic evidentiary item at the third location with the forensic evidentiary item at the first location.

8. The remote forensic evidentiary item examination system of claim 2, wherein the forensic evidentiary item is a bullet.

9. A remote forensic evidentiary item examination method comprising:
mounting a forensic evidentiary item at a fixture of a first station located at a first location, by a first user; and,
examining the forensic evidentiary item at a second station located at a second location different than and remote to the first location, by a second user different than the first user, the second station in communicative connection with the first station.

10. The remote forensic evidentiary item examination method of claim 9, further comprising:
transmitting video of the forensic evidentiary item mounted at the fixture of the first station to the second station, by a video camera of the first station; and,
displaying the video at the second station, by the second station, for viewing by the second user; and,
remotely controlling the video camera by the second user at the second station without assistance from the first user at the first station.

11. The remote forensic evidentiary item examination method of claim 9, further comprising remotely controlling a microscope of the first station by the second user at the second station without assistance from the first user at the first station, where the forensic evidentiary item is viewed through the microscope.

12. The remote forensic evidentiary item examination method of claim 9, further comprising remotely controlling one or more motors of the first station by the second user at the second station without assistance from the first user at the first station, to move the forensic evidentiary item while the forensic evidentiary item is mounted at the fixture of the first station.

13. The remote forensic evidentiary item examination method of claim 9, further comprising:
illuminating the forensic evidentiary item mounted at the fixture of the first station by a light source of the first station; and,
remotely controlling the light source by the second user at the second station without assistance from the first user at the first station.

14. The remote forensic evidentiary item examination method of claim 9, further comprising:
mounting an additional forensic evidentiary item at a fixture of a third station located at a third location different than and remote to both the first location and the second location, by a third user different than both the first user and the second user;
examining the additional forensic evidentiary item at the third station by the second user; and,
comparing the additional forensic evidentiary item at the third location with forensic evidentiary item at the first location, by the second user.

15. The remote forensic evidentiary item examination method of claim 9, wherein the forensic evidentiary item is a bullet.

16. A non-transitory computer-readable data storage medium to store a computer program executable by a processor at a station to perform a remote forensic evidentiary item examination method comprising:
receiving video of a forensic evidentiary item mounted at a fixture of an additional station located at a first location different than and remote to a second location at which the station is located, from a video camera of the additional station, the station in communicative connection with the additional station; and,
displaying the video of the forensic evidentiary item to permit a user at the second location to examine the forensic evidentiary item.

17. The non-transitory computer-readable data storage medium of claim 16, wherein the remote forensic evidentiary item examination method further comprises:
receiving a command to control the video camera, from the user at the second location; and,
transmitting the command to the additional station for the additional station to control the video camera without assistance from any user at the first location.

18. The non-transitory computer-readable data storage medium of claim 16, wherein the remote forensic evidentiary item examination method further comprises:
receiving a command to control a microscope through which the forensic evidentiary item is viewed, from the user at the second location; and,
transmitting the command to the additional station for the additional station to control the microscope without assistance from any user at the first location.

19. The non-transitory computer-readable data storage medium of claim 16, wherein the remote forensic evidentiary item examination method further comprises:
receiving a command to control one or more motors of the additional station, from the user at the second location; and,
transmitting the command to the additional station for the additional station to control the one or more motors to move the forensic evidentiary item while the forensic evidentiary item is mounted at the fixture of the additional station without assistance from any user at the first location.

20. The non-transitory computer-readable data storage medium of claim 16, wherein the remote forensic evidentiary item examination method further comprises:
receiving a command to control a light source of the additional station illuminating the forensic evidentiary item at the first location, from the user at the second location; and,
transmitting the command to the additional station for the additional station to control the light source without any assistance from any user at the first location.

21. The non-transitory computer-readable data storage medium of claim 16, wherein the video is first video, the forensic evidentiary item is a first evidentiary item, the additional station is a first additional station, the video camera is a first video camera, and the remote forensic evidentiary item examination method further comprises:
receiving second video of a second evidentiary item mounted at a fixture of a second additional station located at a third location different than and remote to both the first location and the second location, from a second video camera of the second additional station; and,
displaying the second video of the second evidentiary item to permit the user to examine the second evidentiary item and to compare the second evidentiary item with the first evidentiary item.

22. The non-transitory computer-readable data storage medium of claim 16, wherein the forensic evidentiary item is a bullet.

23. A station for a remote forensic evidentiary item examination system, comprising:
a fixture that is adapted to have a forensic evidentiary item mounted thereat, the station locatable at a first location; and,
a video camera to transmit video to an additional station locatable at a second location different than and remote to the first location to permit a user at the second location to examine the forensic evidentiary item at the first location, the station being in communicative connection with the station.

24. The station of claim 23, further comprising a microscope through which the forensic evidentiary item is viewed.

25. The station of claim 23, further comprising logic to receive a command input by the user at the second location from the additional station, and to control the video camera in accordance with the command without assistance from any user at the first location.

26. The station of claim 23, further comprising:
one or more motors to move the forensic evidentiary item while the forensic evidentiary item is mounted at the fixture of the first station; and,
logic to receive a command input by the user at the second location from the additional station, and to control the one or more motors in accordance with the command without assistance from any user at the first location.

27. The station of claim 23, further comprising:
a light source to illuminate the forensic evidentiary item mounted at the fixture of the first station; and,
logic to receive a command input by the user at the second location from the additional station, and to control the light source in accordance with the command without assistance from any user at the first location.

28. The station of claim 23, wherein the forensic evidentiary item is a bullet.
